(19) United States
(12) Patent Application Publication
(10) Pub. No.: US 2018/0104861 A1
(43) Pub. Date: Apr. 19, 2018

(54) Modular moulding structure for expanding and sintering polystyrene

(71) Applicant: Angelo Candiracci, Fano (PU) (IT)

(72) Inventor: Angelo Candiracci, Fano (PU) (IT)

(21) Appl. No.: 15/537,837

(22) PCT Filed: Dec. 21, 2015
(86) PCT No.: PCT/EP2015/080825

§ 371 Date: Jun. 19, 2017

(30) Foreign Application Priority Data
Dec. 24, 2014 (IT) PS2014A000019

(51) Int. Cl. B29C 33/22; B29C 33/26; B29C 44/44; B29C 44/58

(52) U.S. Cl. CPC B29C 33/22; B29C 33/26; B29C 33/34; B29C 44/58; B29C 44/445

(57) ABSTRACT

A modular mold structure for expanding and sintering polystyrene, particularly for obtaining prefabricated panels with embedding elements, before sintering, includes a plurality of twinned sintering modules or adjacent twin molding units, each having an upper and a lower shell associated by a base, and a raised truss element supporting the upper shell through linear elevation movement and angular rotation movement members, while the truss base portion supports the lower shell preferably through sliding and guide members on the ground, shared by all twinned adjacent molding units, so that the lower shells can be displaced in a block at least on one side and preferably on two sides of the assembly of the upper shells, for displacement arrangement thereof, to be preferably loaded on one side with the a reinforcement system to be embedded in the panels and to be preferably unloaded on the other side of the finished reinforced panels.

### DETAILED DESCRIPTION

### State of the Art

Sintered expanded polystyrene (https://en.wikipedia.org/wiki/Sintering), also commonly referred to as expanded polystyrene (https://en.wikipedia.org/wiki/Polystyrene), is a thermoplastic resin derived from benzene, with lightness, isothermia, waterproof, dimensional stability, rigidity and resistance to knocks, self-extinguishing and non-toxic characteristics.

As regards lightness, EPS has low volume mass or density [from 10 (ten) to 60 (sixty) kg/m3].

As regards isothermia, it is one of the main characteristics of EPS and it is facilitated by the fact that it is 90% formed by air. This air is enclosed in cells so small to prevent the convective motions. Thus, heat transmission may occur solely by conduction, very low in the air, and by radiation, which rapidly reduces upon the multiplication of the screens made up by the walls of the cells. Remaining balanced with respect to the external air, the internal air stabilises heat conductivity over time.

As regards waterproof features and, on the contrary, permeability to water vapour, EPS is not a hygroscopic material, thus products made of EPS do not reveal inhibition phenomena by capillarity. Thus, EPS' right value of permeability to vapour allows the transpiration of the products obtained therewith, thus not vulnerable to mould and the like.

As regards dimensional stability, EPS is isotropic, given that the products obtained therewith are not subjected to tensioning, with ensuing deformation and breakage, regardless of the time of utilisation thereof; actually, there is a physical-mechanical state of balance with homogeneity of characteristics reproduced in all points of the product. Such characteristic is mainly influenced by the type of expansion the material cells are made of. As a matter of fact, the cell structures that expand as a whole within the space of a few millimetres of diameter are extremely regular, with almost identical micro-spheres.

As regards rigidity and reaction to mechanical stresses, the relation between stresses and deformations is linear up to 3% of deformation. Beyond this limit there is a permanent deformation of the cell structure without breakage.

As regards self-extinguishing characteristics, EPS reveals delayed flame propagation characteristics. The products tested as regards reaction to fire have resistance values solely inferior to those made of incombustible material.

As concerns non-toxicity and biological tolerance, EPS is not toxic, it is not represent a source of nutrition for any living being, micro-organisms included; EPS does not rot, it is not attacked by mould and it is completely recyclable, biologically neutral, neutral to odour and neutral to contact with skin.

As regards production technology, expanded polystyrene should be subjected to a series of transformation processes directly related to the intended use thereof before being used.

At the beginning, the material is in form of fine beads, from one to three millimetres of diameter, added with an expanding agent; the production of semi-finished products and polystyrene—expanded polystyrene—products occurs in three main stages.

Pre-expansion: the expandable polystyrene beads are pre-expanded, generally by means of vapour at a temperature exceeding 90 degrees centigrade, in the so-called pre-expander. In the pre-expansion treated with vapour, the raw material softens and the expanding agent evaporates, causing the swelling of the beads. Following the evaporation of the expanding agent, the beads amplify up to sixty times their initial volume. The duration and intensity of this first operation determine the volume mass of the finished product. A closed cell structure, fundamental for the subsequent use as heat insulator, is formed in this process in the expanded polystyrene beads. The degree of expansion, which essentially depends on the duration of heat treatment in the pre-expander, determines the apparent volume mass of the products made of expanded polystyrene and thus all their physical characteristics.

Maturation of the pre-expanded product: At this stage, the polystyrene beads are stationed for a given period of time in aerated silos. Upon cooling, the expanding material and water vapour residues condensate in the single cells. The vacuum thus formed is nullified by the air which spreads in the cells; thus, the pre-expanded polystyrene or expanded polystyrene beads reach the stability required for the subsequent steps.

Modelling the product: pre-expanded and stabilised polystyrene beads may thus be transformed into products or semi-finished products in various ways.

As regards moulding blocks and cutting polystyrene or sintered expanded polystyrene slabs; it is the most used system. The block-making device, constituted by a parallelepiped-shaped element provided with micro-holes for the inlet of vapour on all sides, is filled with polystyrene or expanded polystyrene beads and subjected to a new injection of the saturated vapour; temperatures between 110-120 degrees centigrade are attained at this stage; the beads swell further and join each other due to their internal pressure, i.e. they are sintered. The more the EPS has high density, the more the block is subjected to pressure such to facilitate a better sintering. After a brief cooling period, the blocks are extracted and preferably stored for a variable period of time ranging from a few days to two months, a period during which they reach the stability required for the various applications. From here, the expanded polystyrene blocks are picked up for cutting into panels, which occurs with hot wire cutting lines and other possible mechanical operations, such as shaping using numeric control pantographs or by milling.

For moulding panels or other expanded polystyrene products: The production process is the same described for the production of blocks but the EPS panels are moulded singularly in special numeric control automatic machines. This leads to the advantage of directly obtaining the desired shape, without further mechanical machining processes, sintered beads even in this case; in the EPS, good sintering, i.e. the “bonding” of the beads to each other is very important, actually it is crucial. The more the EPS has high density, the more the block is subjected to pressure such to facilitate a better sintering.

For extrusion-drawing: subsequently to polymerisation, polystyrene or expanded polystyrene is joined to the expanding agent and other possible additives in a drawing machine, which mixes the ingredients in molten state and extrudes the mixture from a die, usually in form of a flat panel, which immediately sinters and expands and stiffens in the expanded form as it cools.

Such characteristics of sintered expanded polystyrene, referred to as EPS, also referred to as expanded polystyrene, find concrete application in the manufacture of building materials, for example according to the technologies described and claimed in the patent applications on behalf of the same Applicant Angelo Candiracci n° PS2014A000004 filed on 18 Mar. 2014 (WO/EP2015/055027) having the title “Prefabricated building product structure made of sintered expanded polystyrene and relative production method” and n° PS2014A000015 filed on 28 Nov. 2014 (PCT/EP2015/077339) having the title “Method for producing panels for building prefabricated houses, panels and prefabricated constructions particularly for humanitarian emergency residential purposes, obtained through such method”.

The method in question provides for the moulding of the composite construction assembly, by aggregating an armour preferably made of steel to the sintered expanded polymeric mass, still preferably of the high density type [from 30 (thirty) to 60 (sixty) kg/m³], by embedding rod-like steel elements therein, preferably preassembled to constitute a mesh or cage of electrowelded elements, still dimensioned and shaped as a function of the shape of the product and/or assembly needs and/or assembly and joining application means; arranging such steel rod-like elements in the polystyrene expansion mould; pouring—into the mould—incoherent granules or beads obtained in the from the polymerisation of styrene, with suitable grain size and volume to attain a high density finished product ([from 30 (thirty) to 60 (sixty) kg/m³]; expansion and sintering i.e. grouping incoherent polystyrene through contact with water vapour and temperature exceeding ninety degrees injected into the mould and the ensuing entrapment of the reinforcement in the monolithic mass thus attained to obtain a solid geometry, defined by the mould, of polystyrene or reinforced sintered expanded polystyrene.

### OBJECTS OF THE INVENTION

In this context, the main object of the present invention is to provide a mould for expanding and sintering polystyrene particularly adapted to implement the method for producing large reinforced sintered expanded polystyrene panels especially for building purposes.

Another object of the present is to attain the preceding object through a suitably large structure for producing the prefabricated building panels made of reinforced sintered expanded polystyrene in a single piece, but simultaneously suitably modularly adapted to produce, within the maximum perimeter defined thereby, substantially any conformation and shape of a reinforced polystyrene panel and accessorised with incorporated elements embedded in the sintered polystyrene mass exclusively where required by the specific needs.

Still another object of the present invention is to attain any one of the preceding objects through an incrementable modular structure with reference to the dimensions, both in terms of expansion and thickness, of the panels that can be produced therewith.

A further object of the present invention is to attain any one of the preceding objects through a structure that allows the easiest loading possible of the articulated and voluminous reinforcing means intended to be incorporated in the sintered polystyrene mass and equally relatively easy unloading and removal of the finished product.

A further object of the present invention is to attain any one of the preceding objects through a structure the most productive, simple and quick possible in the variation of the formats of the products, with the due proportions with respect to the size and complexity of the products in question.

A further object of the present invention is to attain any one of the preceding objects through a device that is simple and functional, safe to use and relatively inexpensive considering the actual results attained therewith.

### SUMMARY OF THE SOLUTION CONCEPT

These and other objects are attained with the modular moulding structure for expanding and sintering polystyrene (eps), according to the present invention, particularly for implementing the method for obtaining prefabricated panels, especially large ones for building purposes, made of reinforced sintered polystyrene, constituted by a composite assembly through the aggregation of steel to the sintered expanded polymeric mass, preferably of the high density type, by embedding steel elements therein, preferably of the preassembled rod-like type to constitute electrowelded cage elements, before sintering, comprising a plurality of twinned sintering modules (1) or adjacent twinned moulding units (1), each constituted by an upper shell (2) and a lower shell (3) associated by a base (6) and raised (5) truss element (4), wherein the raised truss (4) portion (5) supports the upper shell (2) through means for moving in linear elevation (12, 13, 14) and angular rotational movement means (10, 11), while the base portion (6) of the truss (4) supports the lower shell (3) preferably through sliding (17) and guide (15) means on the ground (9) shared by all adjacent twinned moulding units (1), so that the lower shells (3) can be displaced as a block (3), at least on one side and preferably on two sides of the assembly (2) of the upper shells (2) in order to be loaded—in displacement arrangement—preferably on one side with reinforcing means (21) intended to be embedded in the panels (22) and be preferably unloaded on the other side of the finished reinforced panels (22).

### DESCRIPTION OF THE ATTACHED DRAWINGS

Further characteristics and advantages of the modular mould structure for expanding and sintering polystyrene according to the present invention shall be more apparent from the following detailed description of a preferred but non-exclusive embodiment thereof, represented solely by way of non-limiting example with reference to the four attached drawings, wherein:

FIG. 1 illustrates an elevational view of an embodiment of a modular mould for expanding and sintering polystyrene according to the present invention;

FIGS. 2 to 4 comprised respectively illustrate, in lateral view, an embodiment of a modular mould for expanding and sintering polystyrene according to the present invention, in an equivalent number of operative configurations of the relative components;

FIG. 5 illustrates a plan view of an embodiment of a modular mould for expanding and sintering polystyrene according to the present invention;

FIGS. 6 to 8 comprised respectively illustrate a perspective top view of an embodiment of a modular mould for expanding and sintering polystyrene according to the present invention, in an equivalent number of operative configurations of the relative components;

FIGS. 9 to 11 comprised respectively illustrate a perspective top view of an embodiment of a modular mould for expanding and sintering polystyrene according to the present invention, in an equivalent number of operative configurations of the relative components;

### STATIC DESCRIPTION OF A PREFERRED EMBODIMENT

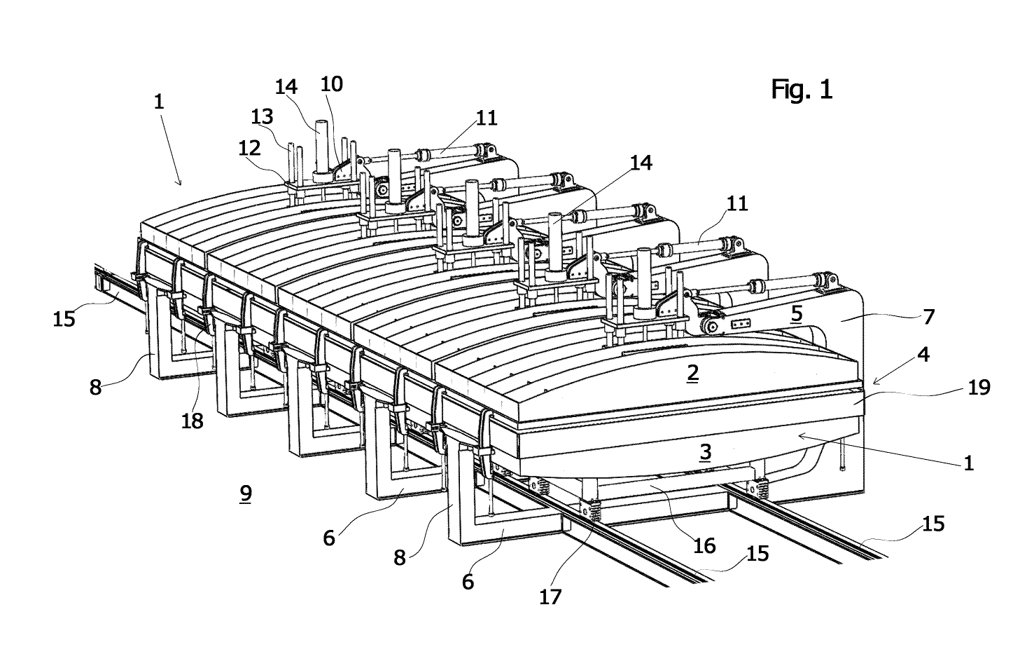

With reference to such figures, in particular FIG. 1, a plurality of identical sintering modules or adjacent twinned moulding units are indicated in their entirety with 1.

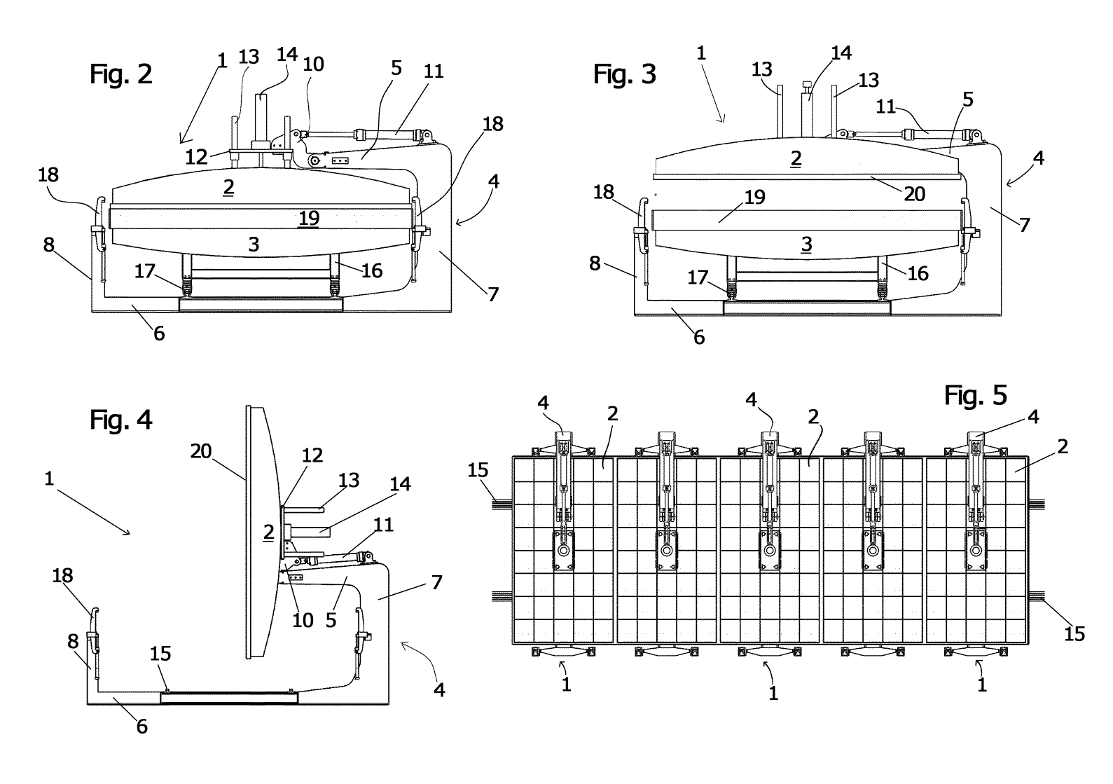

Each moulding unit 1 (also see FIGS. 2, 3 and 4) is constituted by a lower shell 3 or mould and by an upper shell 2 or counter-mould, associated by a fixed truss element 4, comprising a base truss portion 6 extending on the ground 9 under the lower shell 3 and a raised truss portion 5 projecting over the upper shell 2 joined by a rear raised truss portion 7; said truss element 4 being completed by a front raised truss segment 8.

The raised truss portion 5 projects over the upper shell 2 through an arm indicated with the same reference number 5, to which there is apically fulcrumed a lever 10 actuated by a pneumatic cylinder 11 and associated to the resistance with a rectangular plate 12;

the rectangular plate 12 is suspended centrally over the upper shell 2, slidably associated thereto by means of four pins 13 passing therethrough on the four angles and by means of a central pneumatic cylinder 14.

The truss 4 base portion 4, resting on the ground 9, supports the lower shell 3 or mould through a pair of tracks 15, which traverse all the trusses 4 of all adjacent twinned moulding units 1, still extending on two sides of the assembly of the adjacent twinned moulding units 1 of a linear dimension at least equivalent to the linear overall dimension of the same assembly of the adjacent twinned moulding units 1.

Each lower shell 3 is mounted on a chassis 16 which slides on tracks 15 through two pairs of wheels 17, so that all the lower shells 3 can be displaced from the laying position to the respective upper shells 2 in a block, on one side or the other of the assembly of the upper shells 2, respectively supported adjacent by the raised portions 5 of the fixed trusses 4.

Each truss element 4 is provided, on the sides of the rear raised truss portion 7 and on the sides of the front raised truss segment 8, by pairs of fastening elements 18, adapted to mutually fasten the respective lower shells 3 or moulds and upper shells 2 or counter-moulds.

The displacement of all lower shells 3 in a block is actuated through driving means of the known type, not illustrated, which can be conceived both on board the self-propelled assembly as well as the ground; the moulds 1, and the relative modules 1 they are constituted of, shall be considered provided with vapour supply ducts and diffusers, not illustrated, of the known type, as well as polystyrene spherules conveyors and diffusers, not illustrated, of the known type, preferably connected to differentiated suppliers for localised co-sintering of different densities of polystyrene.

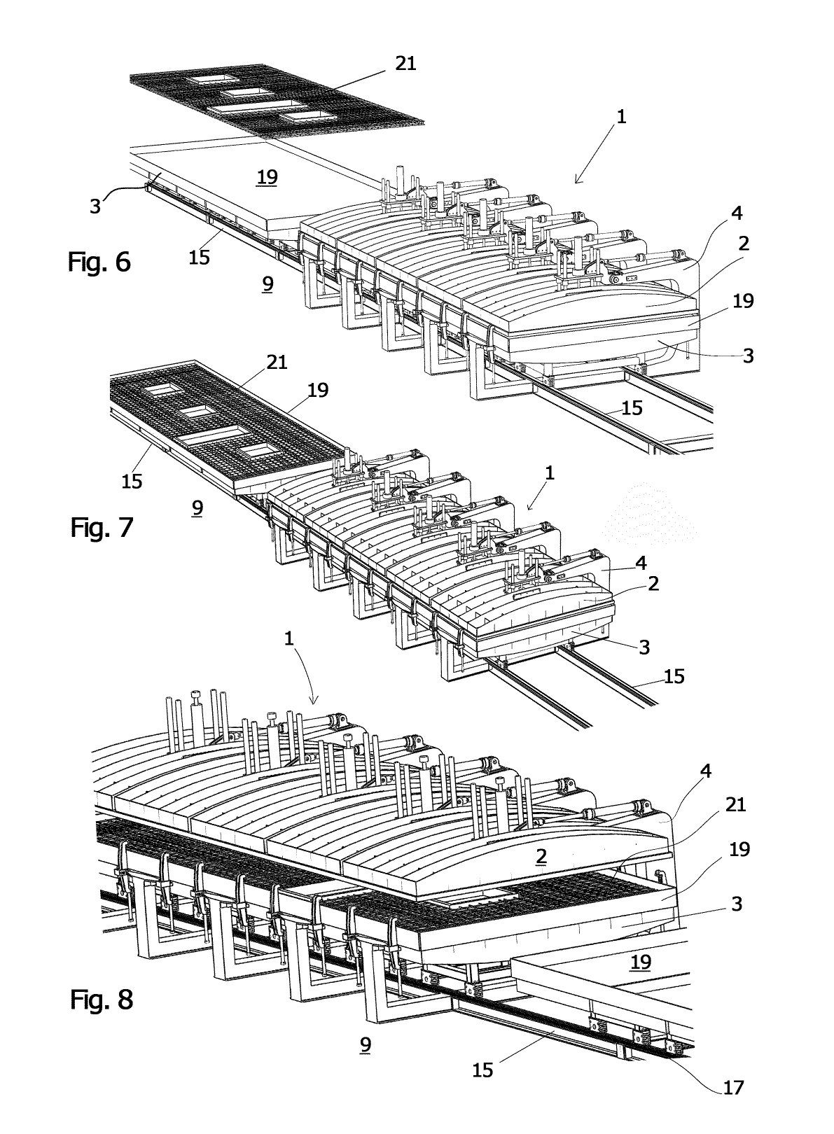

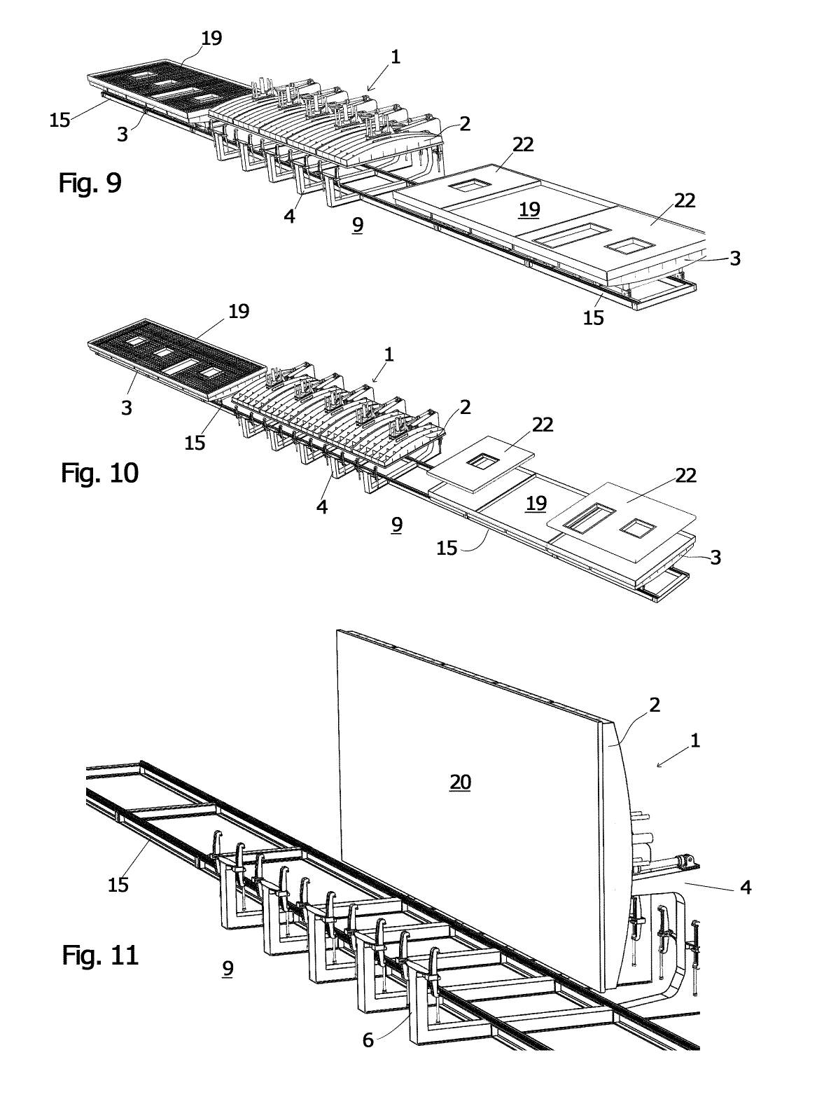

In FIGS. 6 to 11 comprised, the assembly of the sintering modules 1 or moulding units 1 is represented in its various operative configurations, better illustrated in the subsequent chapter dedicated to the dynamic description of the preferred embodiment; in such figures, the assemblies of the upper shells 2 or moulds and lower shells 3 or counter-moulds are indicated with the same reference numbers as the relative units.

In the same FIGS. 6 to 11 comprised, over the assemblies of the lower shells 3 there is illustrated a moulding matrix 19 joining the matrices of the lower shells 3, whose surface shall be deemed perforated in a suitable and known manner for the permeation of the sintering vapour.

Likewise, beneath the assembly of the upper shells 2 there is illustrated a counter-mould plane 20 joining all the counter-mould surfaces of the upper shells 2, which shall also be deemed perforated in a suitable and known manner for the permeation of the sintering vapour.

In the same FIGS. 6 to 11 comprised, the means for reinforcing panels are indicated with 21 and the finished reinforced panels are indicated with 22, for the functions described hereinafter.

### Dynamic Description of the Preferred Embodiment

Thus, having completed the static description of a preferred embodiment of the modular mould structure for expanding and sintering polystyrene obtained according to the present invention, below is the dynamic description:

for this purpose, main reference is made to the object of the invention which is that of obtaining the sintering of reinforced polystyrene panels with the common denominator of having considerable dimensions, but differentiated by the shape, accessorisation and dimensions thereof, for obtaining self-referential building prefabricated products for building innovative constructions exclusively obtained using high density sintered reinforced polystyrene panels;

in this context, the modular moulding structure according to the present invention allows, by providing a suitable plurality of sintering modules 1, or adjacent twinned moulding units 1, as well as, where necessary, by increasing the number, moulding high density sintered reinforcement panels 22, substantially of any dimension, shape accessorisation, that may be required by the contingent construction design and technique.

The production management of the products of such large dimensions is allowed by the transferability as well as the modularity of the moulds:

as regards transferability, the assembly of the lower shells 3, carrying the moulding matrices 19, is actually slidable on the tracks 15, outside the overall dimension of the upper shells 2 or counter-moulds 20, preferably on two sides of the assembly of the upper shells 2, so that the reinforcements 21 of the panels 22 can be easily loaded from above on the matrices 19, carried to be kept in the “open air”, using pulleys, lifts, forklifts and the like:

as regards modularity, the moulding matrices 19 can also be adapted to any dimension, configuration, shape and accessorisation of the panel 22 to be obtained in the relative perimeter, this also being increasable with other modules 1 where necessary, both due to the dimensional and configuration interchangeability, or the change of the mould at will, as well as the positioning of the occluding, partitioning and constraint elements against overflow of the pouring and the ensuing sintering of the spherules, or adaptation to the mould; the entirety in synergically combined association with the modulable activation of the moulding units 1 or moulding modules 1.

Thus, the operating capacity of the machine for loading the reinforcement 21 onto the matrix 19 carried by the lower shells 2 and the relative arrangement thereon, alongside other elements intended to be incorporated to the panel 22, as well as the elements for hindering the spilling of the spherules and the relative sintering, where it is deemed suitable to provide an opening or hole in the finished product, for example at the door or window openings of reinforced panels 22.

Thus, the assembly of the lower shells 2 translates on the tracks 15 up to beneath the assembly of the upper shells 3, joined at the lower part by the counter-mould surface 20, if projecting.

When the symmetricity of the assemblies is complete, i.e. when each lower valve 3 reaches the exact position of the upper valve 2 with which it cooperates to form the single moulding module 1, the suitably set computerised module, which controls the machine in all the functions thereof, controls the upper shells 3 to descend through the plates 12 guided by the four pins 13 and actuated by the cylinders 14 at the apex of the upper arms 5 of the truss 4; the excursion may vary as a function of the height of the mould, thus there can be produced panels substantially of any thickness within the range of usual thicknesses of the specific product.

Upon closing the moulding matrix 19 through the counter-mould 20, the assembly is fastened through fastening elements 18 and flows of polystyrene spherules for are supplied thereinto, still with the suitably programmed computerised logic, according to an amount and arrangement suitable for the specific panel to be constructed, and thus water vapour flows that cause the expansion and sintering of the polystyrene mass are supplied.

At the end, the moulding matrix 19 is opened and the assembly of the lower shells 3 may translate on the other side of the assembly of the upper shells 2, so as to load the reinforcement panel 22 thus finished thereon in the “open air”.

In another embodiment, there may be provided two assemblies of lower shells 3, which are alternatively subjected to the assembly of the upper shells 2 and then receded to the respective positions for loading the reinforcement and unloading the finished reinforced product.

FIG. 11 shows the assembly of the upper shells 2 in a front rotated position thereof, allowed by the absence of the assembly of the lower shells 3 contingently translated on the tracks 15, by rotating the apical levers 10 of each upper arm 5 of the truss 4, so as to allow the inspection, cleaning and replacement of the counter-mould surface 20.

### Alternative Embodiments

It is obvious that in alternative embodiments, still falling within the concept solution of the implementation example illustrated above and claimed below, the modular mould structure for expanding and sintering polystyrene according to the present invention, may also be implemented and obtained differently, through equivalent technical and mechanical solutions still falling within the scope of protection illustrated and claimed below;

In particular:

the truss of the modules, and the structuring of functionally similar support means, may be conceived in a manner such to be displaced in a direction perpendicular to the development of the tracks, according to the illustrated example, so as to move away therefrom; this receding apart movement also leads to the recession of the supported upper shell, so as to allow the rotation thereof even in the absence of translation of the assembly of the lower shells; an alternative embodiment thus obtained, still falling within the solution concept claimed below, shows that there can also be actuated, possibly with the aim of reducing the containment spaces, a machine—though less productive—in which the assembly of the lower shells is not displaced for loading the reinforcement from the top and unloading the finished product but in the “open air” above the assembly of the lower shells is attained by moving the assembly of the upper shells away by receding it.

The truss, for example conceived as a single shaped longitudinal beam in the illustrated embodiment, though such embodiment is deemed preferable in that it is the one most capable of reducing overall dimensions and interferences for economic purposes or other purposes, may be alternatively conceived as framework reticulum, possibly resting against the ground even on the front side of the machine, variously shaped, structured or composed to support the arrangement of the movement of the aerial components of the machine.

The tracks may obviously replaced by any other guiding means suitable for the purpose.

The shape and structuring of the shells and moulding means carried thereby may be of any type, dimension and shape suitable for the purpose.

In addition, as previously mentioned in a description part, the means for driving the block of lower shells, not illustrated in the described embodiment, may be implemented in any known manner suitable for the purpose.

### Advantages of the Invention

As observable from the detailed description of preferred but non-exclusive embodiments above, the modular mould structure for expanding and sintering polystyrene according to the present invention, offers advantages corresponding to the attainment of the preset objects, to which reference shall be made to identify these and other advantages:

it allows the moulding of large sintered reinforcement polystyrene panels designated for building purposes in terms of polyvalent modular elements as a function of different dimensions and shapes as well as providing accessories and thicknesses required by the finished products, particularly for combining to form the elements constituting buildings exclusively obtained with such prefabricated building techniques.

### KEY TO REFERENCE NUMBERS

1) moulding units or modules
2) upper shells
3) lower shells
4) trusses
5) raised truss portions or upper truss arm
6) base truss portions
7) rear raised truss portions
8) front raised truss segments
9) ground
10) upper shells angular rotation levers
11) pneumatic cylinders for actuating the upper shells angular rotation levers
12) rectangular plates for slidably axially supporting the upper shells
13) guide pins for the axial excursion of the upper shells
14) pneumatic cylinders for actuating the axial excursion of the upper shells
15) tracks
16) lower shells chassis or framework
17) lower shells wheels
18) fastening elements for the mutual fastening of upper and lower shells
19) combined moulding matrix of the lower shells
20) combined counter-mould surface of the upper shells
21) panel reinforcements
22) reinforced panels

The invention claimed is:

1. A mold structure for expanding and sintering polystyrene, particularly for prefabricated panels made of reinforced sintered expanded polystyrene, having a composite assembly through aggregation of reinforcement structures to a sintered expanded polymeric mass by embedding elements therein before sintering, comprising:
a plurality of twinned sintering modules (1) or twin molding units (1), each having an upper shell (2) and a lower shell (3) associated by a support system (4) adapted to keep them superimposed,
wherein a raised truss portion (5) of the support system supports the upper shell (2) through linear elevation movement members (12, 13, 14) and angular rotation movement members (10, 11), and
wherein a base portion (6) supports the lower shell (3).

2. The mold structure according to claim 1, wherein said base portion (6) of said support system (4) supports the lower shell (3) through sliding (17) and guiding (15) members on the ground (9), shared by all adjacent twin molding units (1), so that the lower shells (3) are displaceable as a block (3) at least on one side of an assembly (2) of the upper shells (2), displaced with the reinforcement structures (21) intended to be embedded in the panels (22) and be unloaded.

3. The mold structure according to claim 1, wherein said raised portion (6) of said support system (4) supporting said upper shells (2) are arranged so that the assembly of all the upper shells (2) disengages a vertical of the block (3) of the lower shells (3).

4. The mold structure according to claim 1, wherein it comprises a plurality of twinned sintering modules (1) or adjacent twin molding units (1), each having an upper shell (2) and a lower shell (3) associated by a truss element (4) having a base portion (6) and an elevated (5) portion, wherein the raised truss (4) portion (5) supports the upper shell (2) through linear elevation movement members (12, 13, 14) and angular rotation movement members (10, 11), while the base portion (6) of the truss element (4) supports the lower shell (3) with sliding (17) and guiding (15) members on the ground (9), shared by all the adjacent twinned molding units (1), so that the lower shells (3) are displaceable as a block (3) at least on one side of an assembly (2) of the upper shells (2), such to be displaced.

5. The mold structure according to claim 1, wherein:
each molding unit (1) comprises a lower shell or mold (3) and by an upper shell or counter-mold (2) associated by fixed truss elements (4) that comprise a base truss portion (6) extending to the ground (9) under the lower shell (3) and a raised truss portion (5) projecting over the upper shell (2);
the raised truss portion (5) projects over the upper shell (2) through an arm (5) to which there is pivoted a lever (10) actuated by a linear actuation device (11), the lever being to a plate (12) suspended over the upper shell or counter-mold (2) and slidingly associated to the upper shell or counter-mold through a retention and guide element (13) and through a linear implementation element (14);
the base truss base portion (6) closest to the ground (9) supports the lower shell or mold (3) through a guide element (15) which traverses all trusses (4) of all adjacent twinned molding units (1), still extending on at least one of two sides of the assembly of an adjacent twin molding units (1) with a linear dimension at least equivalent to an overall linear dimension of the assembly of the twin adjacent molding units (1); and
every lower shell or mold (3) is mounted on a support system (16) movable on said guide element (15) through rolling or sliding elements (17), so that all the lower shells or molds (3) are displaceable as a block from a laying position to the respective upper shells or counter-molds (2) at least on one side or on one side and on another side of the assembly of the upper shells or counter-molds (2) respectively supported adjacent by the raised portions (5) of the fixed trusses (4).

6. The mold structure according to claim 5, wherein above the assembly of the lower shells or molds (3) there is arranged a molding matrix (19) joining all matrices (19) of the lower shells or molds (3).

7. The mold structure according to claim 6, wherein beneath the assembly of the upper shells or counter-molds (2) there is arranged a counter-mold plane (20) joining all the counter-mold planes (20) of the upper shells or counter-moulds (2).

8. The mold structure according to claim 6, wherein:
the twinned sintering modules (1) or twin molding units (1), and hence the lower shells or molds (3) and the upper shells or counter-molds (2), are provided with supply pipes and vapor diffusers and with elements that convey and diffuse polystyrene beads; and
the single and combined molding matrices (19) of the lower shells or molds (3) and the single and combined counter-molding planes (2) are perforated for permeation of sintering vapor.

9. The mold structure according to claim 1, wherein a displacement of all the lower shells or molds (3) in block is actuated through motorization arranged on board a self-propelling assembly or on the ground.

10. The mold structure according to claim 1, wherein the support system (4) of the lower shells or molds (3) and the upper shells or counter-molds (2) are provided with fastening elements (18) adapted to mutually fasten the lower shells or molds (3) and upper shells or counter-molds (2).
